(19) United States
(12) Patent Application Publication
(10) Pub. No.: US 2005/0098744 A1
(43) Pub. Date: May 12, 2005

(54) Process and device for measuring the length and/or the diameter of filter bars

(75) Inventors: Dierk Schroder, Hamburg (DE); Michael Haul, Kroppelshagen (DE); Andreas Rinke, Bad Oldesloe (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/658,201

(22) Filed: Sep. 10, 2003

(30) Foreign Application Priority Data
Sep. 11, 2002 (EP) 02 020 291.7

(51) Int. Cl. G01V 8/00; G01N 21/86; G06M 7/00

(52) U.S. Cl. 250/559.19; 250/223 R

(57) ABSTRACT

Process and device for measuring bar-shaped articles. The process includes conveying the bar-shaped articles in a conveyor line, and optically measuring at least one physical property of the bar-shaped articles. The device includes an optical measuring device structured and arranged to measure at least one physical property of the filter bars. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of European Patent Application No. 020 20 291.7 filed Sep. 11, 2002, the disclosure of which is expressly incorporated by reference herein in its entirety.

### BACKGROUND OF THE INVENTION

1. Field of the Invention

The present invention relates to a process for measuring at least one physical, in particular geometric, property of bar-shaped articles of the tobacco processing industry, in particular filter bars, conveyed in a conveyor line. Furthermore, the invention relates to a device for conveying filter bars to a filter magazine. In this manner, filter bars conveyed in a lengthwise axial manner can be fed to the filter magazine in a crosswise axial manner.

In the current context, “bar-shaped articles” refers to cigarettes, filter bars, filter cigarettes and similar bar-shaped objects with a preset diameter and a predetermined length. However, it is noted that this listing is not exhaustive, and that other bar-shaped articles contemplated by those ordinarily skilled in the art can be utilized in accordance with the invention.

2. Discussion of Background Information

In the manufacture of products produced in a rod process, e.g., filter bars, the aim is to keep diameter fluctuations as low as possible. Deviations in the diameter of a filter rod can be particularly harmful since, with filter cigarettes composed of filter plugs and cigarettes, the plugs and cigarettes have to have the same diameter so that their joining, in particular by a connecting sheet, can take place without gaps remaining between the sheet and the plug or the cigarette, through which secondary air could enter and impair the smoking properties.

A device for conveying filter bars to a filter magazine or a corresponding process for conveying filter bars to a filter magazine is known from the assignee's filter bar loading system “FILTROMAT 3 FE.” Such a filter bar loading system or such a filter bar receiver receives filter bars conveyed in a lengthwise axial manner that are first braked in order to then be accelerated in a lengthwise axial manner. Subsequently, the filter bars are fed to the filter magazine in a crosswise axial manner. In this connection, various module variants are known. For example, there are individual receivers, double receivers and triple receivers. In this connection it is possible to regulate the speed of the filter bar receiver depending on the requirement for filter bars.

Moreover, published patent application German Patent Application No. DE-A-197 40 070 describes a conveyor device for transporting filter bars between a sending station and a receiving station via a pneumatic conveyor line.

Furthermore, German Patent No. DE-C-34 14 247 discloses a device for measuring the diameter of filter bars, whereby the diameter measurement of the filter bars is conducted by a pneumatic testing system.

### SUMMARY OF THE INVENTION

The present invention conducts a testing and checking of filter bars simply and quickly while they are being conveyed into a filter magazine. In this way, it is possible to exactly determine different physical properties of the filter bars.

According to the instant invention, the process of the type mentioned at the outset further includes that the at least one physical property is measured in an optical manner. “Physical properties” of a filter bar refers to, in particular, variables of state and/or dimensions of the filter bar, such as, e.g., length and diameter. By the solution according to the invention it is possible to examine each filter bar quickly and precisely while the filter bar is being conveyed to a magazine. In this regard, a kind of input check or monitoring of the filter bars is conducted before the magazine, so that the production process of filter cigarettes can be improved as a whole, since only filter bars with predetermined properties are conveyed to the magazine.

Preferably, the length and/or the diameter of the articles are measured as physical properties of the bar-shaped articles. Based on the geometric dimensions of the filters, their diameter and/or length can be continuously monitored.

Within the scope of the invention, it is possible for at least two different physical properties to be measured. In this manner, the (input) monitoring of the filter bars is improved by measurement of two characteristic states or properties.

In a further development of the invention, it is provided that the at least two different physical properties are measured at the same time, so that the expenditure in terms of equipment is kept low since, for instance, two properties, diameter and length, can be determined simultaneously by one measuring device.

According to a preferred embodiment, one physical property is measured several times, in particular simultaneously. Through this, for example, more precise measuring results and information, e.g., on the diameter of the (individual) filter bars, is achieved.

If, for instance, a test chamber, as is described in patent German Patent No. DE-C-34 14 247, is provided in the conveyor line, it is additionally possible for a physical property to be measured pneumatically. This measurement can be made additionally or alternatively to the optical diameter measurement.

Furthermore, it is provided in a further development that, after measuring at least one physical property, it is examined whether the measuring result lies within a predetermined measurement tolerance range, so that the input check of the filter bars is improved and the quality of filter cigarettes produced with the tested filters is thus increased. The invention is based on the concept that through the quality control of certain physical, in particular geometric, properties of the filter bars, only flawless filter bars are used to produce filter cigarettes. With format lengths of 60 to 180 mm, the filter bars should therefore be within a preset tolerance range of, e.g., 0.1 mm, so that only tested filter bars are admitted for the further manufacturing process. This quality control of filter bars has given good results in particular when multi-segment filters are subsequently made from the tested filter bars, since in this way according to the invention individual segments of a multi-segment filter are prevented from having physical, e.g., geometric, defects. Alternatively, multi-segment filters are conveyed as filter bars through the conveyor line and tested for their physical properties.

Furthermore, it is proposed that in the event of a deviation of the measuring result, the article is removed from the conveyor line and/or the manufacturing process, so that only filter bars with a preferred quality are used to produce multi-segment filters and filter cigarettes.

Moreover, according to a further development of the process, it is provided that the measuring takes place after a start signal is triggered, in particular, a light barrier. When a light barrier is interrupted by a conveyed filter bar, a start signal is produced so that the measuring device is activated after a certain period of time has elapsed. With serially conveyed filter bars in a conveyor line, each individual filter bar is thus tested.

In particular, the at least one physical property is measured in the end area of the article. The length can be ascertained by ascertaining the exact position of the head area or both head areas of the article.

Furthermore, the measuring, in particular the measuring of the length, can be performed by two measuring points along the conveying zone of the articles.

The articles and/or the measuring points are preferably impinged upon by light from at least one light source, in particular laser light source. The one physical property is preferably measured based on the area of the articles impinged upon by the light source and based on the brightness profile or shadow produced. The dimensions of the article can be determined very precisely by the produced shadow or shadow image of an illuminated article.

The brightness profile is detected in particular by a sensor, in particular a line sensor. Such line sensors have given good results in high-speed sensing for the diameter and edges of objects.

Furthermore the invention provides a device of the type mentioned at the outset that further includes an optical measuring device for measuring at least one physical property of the filter bars.

The measuring device is advantageously embodied for measuring geometric properties of the filter bars.

The measuring device is preferably arranged along a conveyor line of the filter bars, in which the filter bars are conveyed in a lengthwise axial manner.

To embody an input quality control, the measuring device is preferably arranged between a braking device, in particular, a pair of braking rollers and an accelerating device, in particular, a pair of accelerating rollers, for the filter bars.

According to an alternative embodiment, it is provided that the measuring device is arranged on a crosswise conveying device, in particular a drum, for the filter bars. The geometric properties of the filter bars can be detected on the drum by this device. Thus, only one measuring point is necessary when the length of the filter bars is being measured, since a defined measuring point or reference point is provided by a fixed stop point for the filter bar on the drum.

In order to embody a high-speed sensing, the measuring device is embodied with at least one light source, in particular a laser light source, and with at least one sensor, in particular a line sensor.

It is particularly advantageous if the measuring device is embodied such that the length and the diameter of the filter bars are measured at the same time. This increases the informative value of the input control of filter bars during their transfer to a filter magazine. In all, only tested and measured filter bars are admitted to the manufacturing process of filter cigarettes or multi-segment filters.

If only one light source, in particular a laser light source, is to be used for the measuring, it is provided that the measuring device features at least one mirror or a mirror arrangement. Moreover, the cost is reduced by the use of only one laser light source and possibly one line sensor.

Furthermore, in a particularly preferred embodiment an evaluating device for the measuring results of the measuring device is provided.

According to an advantageous further development of the invention, it is moreover suggested that the evaluating device be connected to an ejection device for the filter bars, so that only flawless filter bars are conveyed to the filter magazine. If the measuring results for a filter element are outside a predetermined tolerance range, this defective filter bar is extracted from the conveyor line by means of this selecting device.

The invention is directed to a process for measuring bar-shaped articles. The process includes conveying the bar-shaped articles in a conveyor line, and optically measuring at least one physical property, of the bar-shaped articles.

According to a feature of the invention, the at least one physical property can be a geometric property.

In accordance with another feature of the present invention, the bar-shaped articles can include filter bars.

According to the invention, the process can be performed on bar-shaped articles of the tobacco processing industry.

Further, the at least one physical property can include at least one of a length and a diameter of the bar-shaped articles.

Moreover, at least two different physical properties of the bar-shaped articles may be measured. The at least two different physical properties may be measured at a same time.

In accordance with still another feature of the instant invention, the at least one physical property can be measured several times.

The at least one physical property may include at least two physical properties, and the at least two physical properties can be measured several times. The at least two physical properties may be measured simultaneously.

The process can further include comprising pneumatically measuring the at least one physical property.

According to another feature, after measuring the at least one physical property, the process may also include, determining whether the at least one measured physical property lies within a predetermined measurement range.

Still further, when the measured physical property lies outside of the predetermined measurement range, the process can also include removing the bar-shaped article from at least one of the conveyor line and the manufacturing process.

The process may also include triggering a start signal. The measurement of the physical property can occur after the start signal is triggered. The start signal may be triggered by a light barrier.

According to still another feature of the invention, the at least one physical property can be measured in the end area of the bar-shaped articles.

Moreover, two measuring points may be arranged along a conveying zone of the bar-shaped articles, and the measuring can be performed by the two measuring points along the conveying zone of the articles. The two measuring points can be arranged to measure the length of the bar-shaped articles. The process can also include impinging light upon at least one of the bar-shaped articles and the two measuring points. At least one light source can be positioned to impinge light upon the at least one of the bar-shaped articles and the two measuring points. The at least one light source may include a laser light source. The measurement of at least one physical property may be based on an area of the article impinged upon by the light source and based on a brightness profile produced. Further, the brightness profile can be detected by a sensor, and the sensor may include a line sensor.

The present invention is directed to a device for conveying bar-shaped articles to a magazine. The device includes an optical measuring device structured and arranged to measure at least one physical property of the filter bars.

According to the instant invention, the bar-shaped articles can include filter bars and the magazine can include a filter magazine. The device can also include a device that conveys the filter bars in a lengthwise axial manner and feeds the filter bars to the filter magazine in a crosswise axial manner.

In accordance with a feature of the invention, the measuring device can be positioned to measure geometric properties of the bar-shaped articles.

The device may also include a conveyor line arranged to convey the bar-shaped articles, and the measuring device can be arranged along the conveyor line.

Moreover, the device can include a braking device and an accelerating device for the bar-shaped articles, and the measuring device may be located between the braking device and the accelerating device. The braking device can include a pair of braking rollers, and the accelerating device can include a pair of accelerating rollers.

Still further, the device may also include a crosswise conveying unit for the bar-shaped articles, and the measuring device can be located on the crosswise conveying device. The crosswise conveying device can be a drum.

The measuring device may include at least one light source and at least one sensor. The at least one light source may include a laser light source and the at least one sensor can include a line sensor.

According to a feature of the invention, the measuring device can, be structured and arranged to measure a length and a diameter of the bar-shaped articles at a same time.

In accordance with still another feature of the invention, the measuring device can include one of at least one mirror and a mirror arrangement.

The device can also include an evaluating device structured and arranged to evaluated measurements from the measuring device. Moreover, the device can include an ejection device structured and arranged to eject the bar-shaped articles that is coupled to the evaluating device.

The present invention is directed to an apparatus that includes a conveyor for bar-shaped articles, and a measuring device coupled to the conveyor to measure at least one geometric property of the bar-shaped articles.

According to the invention, the measuring device can include a unit for measuring at least one of a length and a diameter of the bar-shaped article. The length and the diameter may be simultaneously measured. Further, the measuring device can include a light source and an optical receiver, and the bar-shaped articles may be conveyed through light emitted from the light source, and the measurement is based upon an amount of the light emitted from the light source that is blocked from the optical receiver by the bar-shaped articles. Still further, a position of both ends of the bar-shaped articles can be concurrently detected in order to measure the length of the bar-shaped articles. Also, two orthogonal diameters of the bar-shaped articles may be concurrently detected in order to measure the diameter of the bar-shaped articles.

The present invention is directed to a process for providing bar-shaped articles that includes conveying the bar-shaped articles, and measuring at least one geometric property of the bar-shaped articles.

In accordance with still yet another feature of the instant invention, the measured geometric property can include at least one of a length and a diameter of the bar-shaped article. The process can also include simultaneously measuring the length and the diameter. The bar-shaped articles may be conveyed through light emitted from a light source, and the measurement may be based upon an amount of the light emitted from the light source that is blocked from an optical receiver by the bar-shaped articles. The process can also include concurrently detecting a position of both ends of the bar-shaped articles in order to measure the length of the bar-shaped articles. Moreover, the process may also include concurrently detecting two orthogonal diameters of the bar-shaped articles in order to measure the diameter of the bar-shaped articles.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a side view of a receiving station;

FIG. 2 diagrammatically illustrates a measuring device in accordance with the present invention;

FIGS. 3a and 3b illustrate brightness intensity profiles in the end areas of a filter element;

FIG. 4 diagrammatically illustrates a further measuring device according to the invention;

FIG. 5 illustrates a brightness intensity profile;

FIG. 6 illustrates a cross-wise view of the measuring device detecting the diameter of filter bars;

FIGS. 7a through 7c diagrammatically illustrate various views of a further measuring device in accordance with the invention; and

FIG. 8 illustrates a cross-sectional view of a further measuring device according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

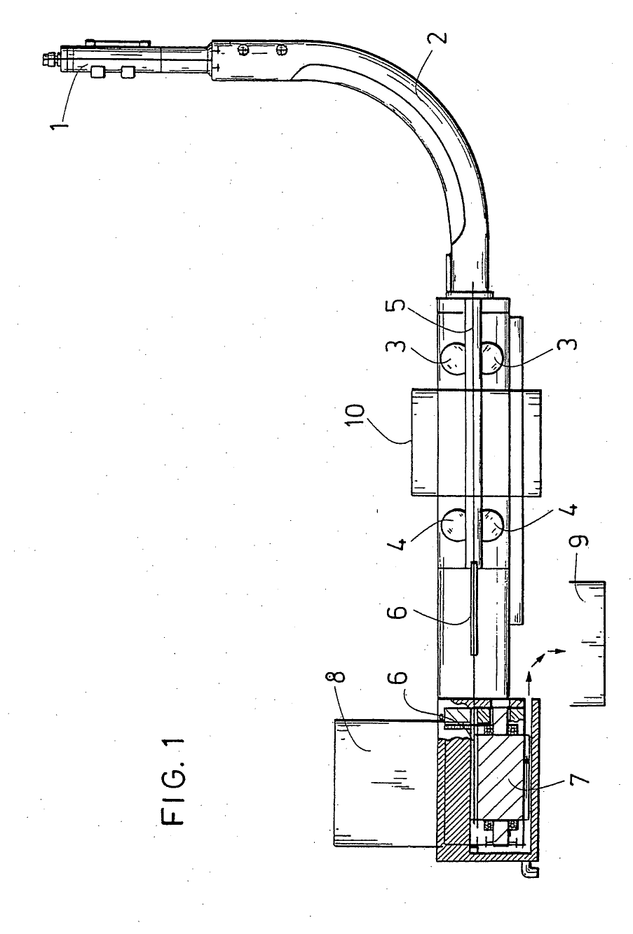

FIG. 1 shows a filter bar receiver for conveying filter bars 6 to a filter magazine 8. After they have been cut, e.g., into filter bars of double working length, filter bars 6 are introduced into filter magazine 8 to be brought together with filter stick pairs in order to produce filter cigarettes.

Filter bars 6 fed into filter magazine 8 can be cut into corresponding filter segments and be fed to an arrangement of filter segments for the production of multi-segment filters. For this purpose, the device can be assigned to several or all functional units of a device for assembling groups of filter segments to produce multi-segment filters of the tobacco processing industry according to the assignee's commonly owned German Patent Application No. DE 101 55 292.0, the disclosure of which is expressly incorporated by reference herein in its entirety.

Filter bars 6 with an n-fold working length are fed to a connecting line 1 by a filter bar sender via a pipeline (not shown here) of a filter production machine. Filter bars 6 are conveyed in a spaced manner to connecting line 1 in the feed pipe and then arrive in a curved guide 2, in order to be braked in a channel 5 by braking rollers 3. Then, filter bars 6 are conveyed by an accelerating roller 4 via a guide (not shown) into a drum 7. Drum 7 has seat grooves in which conveyed filter bars 6 are arranged. Further details can be taken from the assignee's commonly owned European patent application “Vorrichtung und Verfahren zur Forderung von stabfbrmigen Filterelementen [Device and process for conveying bar-shaped filter elements]” filed Sep. 11, 2003, and the disclosure of which is expressly incorporated by reference herein its entirety.

Between braking roller pair 3 and accelerating roller pair 4, a measuring device 10 according to the invention is arranged for measuring the physical property, e.g., the length and/or diameter, of filter bars 6. If it is determined by measuring device 10 that a certain filter bar 6 does not meet preset quality criteria, the corresponding filter bar 6, which is situated on drum 7, is removed from drum 7 via an ejection device (not shown here) and is ejected into a receptacle 9. Thus, defective filter bars 6 are removed from the further manufacturing process.

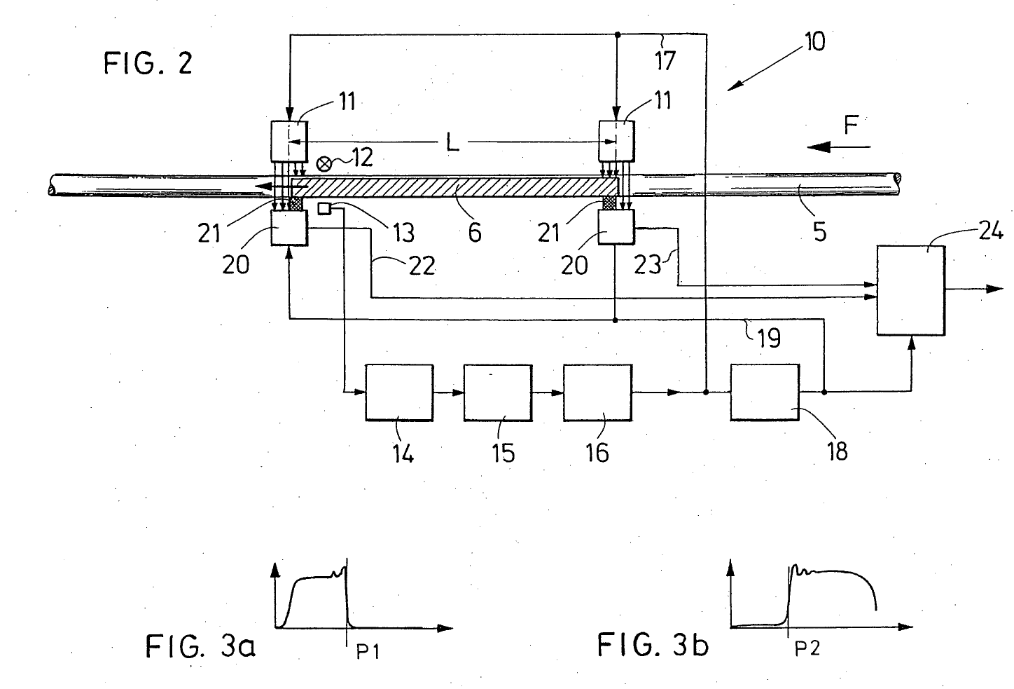

In FIG. 2 a measuring device 10 is shown diagrammatically, by which the length of filter bar 6 is ascertained. Filter bar 6 is transported in channel 5 in a conveying direction F. The front head end of filter bar 6 thereby interrupts the light beam of a light barrier comprising lamp 12 and sensor 13. By the interruption of the light barrier, it is determined by the edge detector 14 connected to sensor 13 that the light barrier was interrupted by filter bar 6. This activates a delay element 15 that then switches on a start element 16 after a predetermined period of time has elapsed. The time period of delay element 15 essentially corresponds to the period of time needed by filter bar 6 to travel from the light barrier with its ends into the measurement range of the two measuring points arranged at the distance of filter length L. After start element 16 has been triggered, two laser light sources 11 are activated simultaneously via a line 17. Laser light sources 11 are preferably embodied as laser pulse sources.

The two laser light sources 11 are arranged with a spacing L that essentially corresponds to the length of filter bars 6. The ends of filter bar 6 are respectively impinged upon by light by the emitted laser pulse with a predetermined width. One part of the laser beam is blanked out thereby by the respective head end, while the other part is detected by a sensor 20 unhindered, in particular a line sensor. The blanking-out of one part of the laser beam causes a shadow 21 to form on the side of filter bar 6 facing away from laser light source 11, so that this shadow area 21 is detected as a dark point in a brightness intensity profile.

At the same time as laser light sources 11 are triggered, another start element 18 for sorting the brightness values or the intensity profiles of sensors 20 is activated by start element 16. Start element 18 is connected via a connection 19 to two line cameras 20 arranged in the end area of filter bar 6. Triggered by start element 18, the intensity values of line cameras 20 are given via lines 22 and 23 to a microcomputer 24, by which the brightness courses in line cameras 20 are evaluated.

FIGS. 3a and 3b show intensity courses of the brightness, which are detected at the front head end (in the conveying direction) and rear head end of filter bar 6 respectively. Based on the brightness jump at the front end (FIG. 3a) and a pixel number of line camera 20 that can be ascertained by the microcomputer 24, a starting point can be ascertained exactly and, thus, the position of the head of filter bar 6. The same also applies to the area of filter bar 6 that is behind in the conveying direction (FIG. 3b), so that the length of filter bar 6 is determined based on the two ascertained positions P1 and P2 and the distance between the brightness jumps, which are respectively detected by line cameras 20.

For detecting the positions of the head/end areas of filter bars 6, e.g., Schafter+Kirchhoff GmbH, Hamburg (Germany) laser projection and diffraction measuring systems comprising pulse laser diodes and CCD line cameras are suitable.

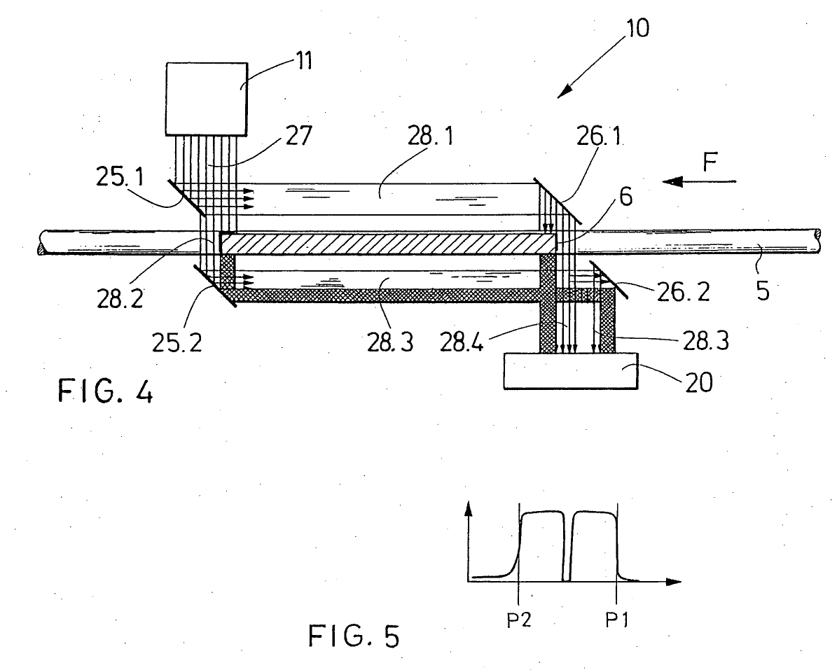

FIG. 4 shows another example of a measuring device 10 according to the invention, in which the length of filter bar 6 is ascertained by only one laser light source 11 and one line sensor 20. A streak of light 27, which is emitted by laser light source 11, is divided into two partial beams 28.1 and 28.2. First partial beam 28.1 is deflected by 90° at a mirror 25.1, so that partial streak of light 28.1 is conducted lengthwise and parallel to filter bar 6. Second partial streak of light 28.2 impinges upon the (front) head area of the filter bar 6 partially, so that at a second mirror 25.2, only a part of the partial streak of light 28.2 is reflected. A shadow area is blanked out from the other part of the partial streak of light 28.2 by the rear head end. The partially blanked out partial streak of light 28.2 is conducted as a partial streak of light 28.3 parallel to the partial streak of light 28.1 and reflected by 90° at a mirror 26.2, so that the brightness intensity profile of this partial streak 28.3 is directed to line sensor 20.

The non-blanked out partial streak of light 28.1 conducted parallel to filter bar 6 is deflected by 90° at a mirror 26.1 in the area of the second (rear) head end, so that a part of this deflected streak of light 28.1 is blanked out by the second head end of the filter bar 6 and is passed to the line sensor 20 as a partial streak of light 28.4.

For conducting the streaks of light, pairs of mirrors 25.1, 25.2, and 26.1, 26.2 are arranged parallel to one another and staggered as well as at an angle of 45° crosswise to filter bar 6 or to channel 5, respectively.

The intensity profile detected by line sensor 20 is shown in FIG. 5, whereby based on the brightness jumps the exact positions P1 and P2 of the end areas of filter bar 6 are calculated and, thus, the length of filter bar 6 is determined.

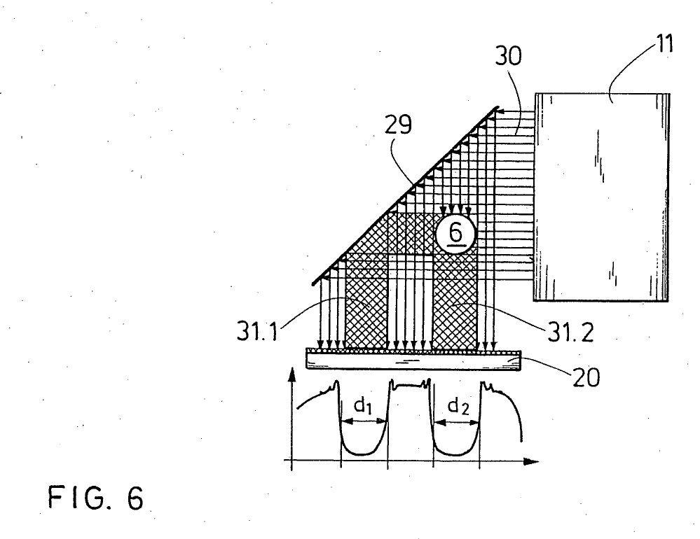

A further example of a measuring device according to the invention is shown diagrammatically in cross section in FIG. 6. The diameter of filter bar 6 can be ascertained twice by the measuring device. A streak of light 30 with a predetermined width is emitted by laser light source 11, which streak of light is deflected by 90° at a mirror 29 arranged obliquely at 45° to the horizontal and tilted towards the streak of light 30. A (lower) part of streak of light 30 meets filter bar 6 horizontally and produces a horizontal shadow with the width of a first diameter d₁ of filter bar 6, which is retained as shadow 31.1 on line sensor 20. A second part of streak of light 30 is first reflected at the mirror 29 and strikes filter bar 6 vertically, so that a vertical shadow 31.2 with a width of a second diameter d₂ is produced on line sensor 20. Both diameter d₁ and diameter d₂ of filter bar 6 are ascertained simultaneously in one measurement by the brightness intensity profile.

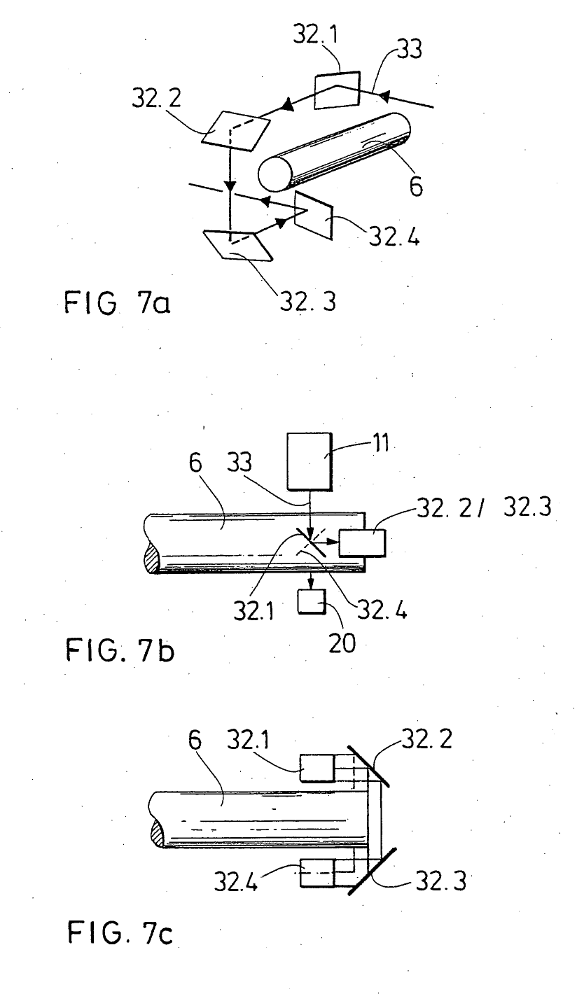

A further measuring device is shown diagrammatically in FIGS. 7a through 7c, by which the position of the end area of filter bar 6 can be determined exactly, so that by these detected position data, together with a further measuring device at the other end of filter bar 6, the length of filter bar 6 is ascertained.

A perspective view of this embodiment of the invention is depicted in FIG. 7a. A light beam 33 emitted by a laser light source is deflected by a mirror arrangement comprising mirrors 32.1, 32.2, 32.3, and 32.4. Mirrors 32.1, 32.2, 32.3, and 32.4 are arranged to form a sort of photon staircase, whereby light beam 33 above filter bar 6 is deflected by 90° by mirror 32.1 and is guided in a lengthwise axial manner parallel to filter bar 6 to mirror 32.2. Mirror 32.2 and mirror 32.3 are arranged at the end area or head area of filter bar 6, namely so that light beam 33 deflected and sent to mirror 32.2 is conducted so that it grazes the head end of filter bar 6, so that a part of the light beam deflected by mirror 32.2 is blanked out by the head end of filter bar 6. The non-blanked out part of this light beam is conducted further by mirror 32.3 to mirror 32.4, which further conducts the partly blanked out light beam to a line sensor.

The exact position of the head end of the filter bar 6 can be ascertained by means of the intensity course of the partly blanked out light beam.

FIG. 7b shows a top view of the measuring arrangement with the mirrors 32.1 and 32.2. Mirror 32.3 is covered by upper mirror 32.2, since they are arranged vertically one above the other. Mirror 32.4, which is arranged below mirror 32.1 and filter bar 6, is shown by a dashed line. The light beam reflected by mirror 32.4 and partly blanked out is detected by line sensor 20.

FIG. 7c shows the measuring arrangement in longitudinal section. The light beam conducted further by mirror 32.3 is partially blanked out and forms a shadow on mirrors 32.3 or 32.4 respectively.

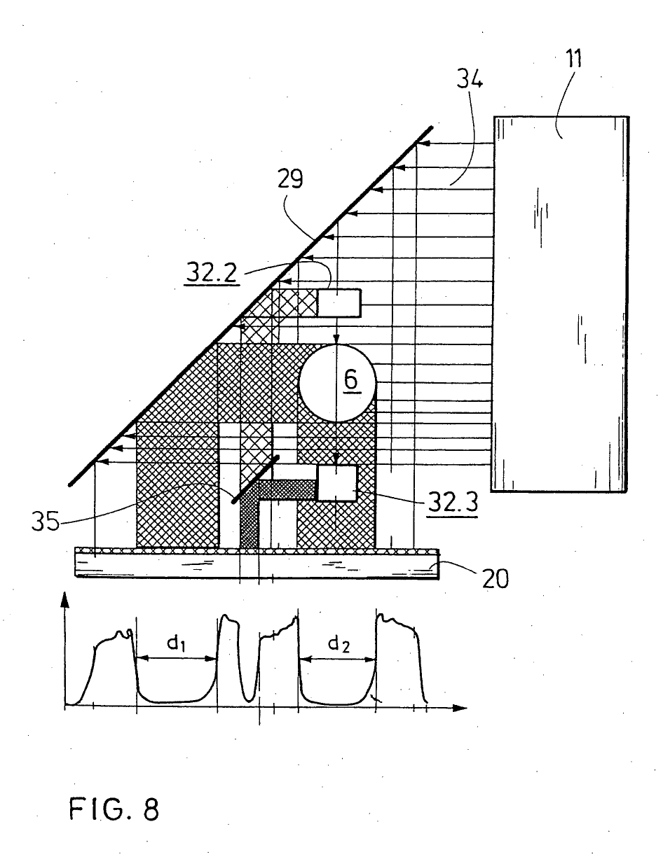

FIG. 8 shows in a diagrammatic crosswise view a combination of the diameter measurements of filter bar 6 as shown in FIG. 6 and the position measurements of filter bar 6 as shown in FIGS. 7a through 7c. Through the combination of these two combined arrangements of mirrors, diameter d₁ and d₂ of filter bar 6 can be measured twice at the same time and, in addition, a position measurement P of the head end of filter bar 6 can be ascertained simultaneously by one light source and one line sensor. To give the position, a further mirror 35 is arranged parallel displaced to mirror 29 and deflects to line sensor 20 the light beam partially blanked out by the head end of filter bar 6, which light beam is deflected by mirror 32.2 and is conducted to mirrors 32.3 or 32.4 (not shown here) respectively. Based on the intensity course of the brightness along line sensor 20, the diameter of filter bar 6 (diameter d₁ and d₂) is ascertained twice. At the same time, position P of the head end is determined.

Within the scope of the invention it is provided that a measuring arrangement is embodied at both head ends of filter bar 6 respectively, which are arranged preferably displaced by, e.g., 45° to one another around filter bar 6 or channel 5, so that the length of the filter bar is determined exactly by the ascertained position data of the head ends and at the same time a diameter measurement takes place with a total of four measurements in the area of the head ends. The measuring arrangements can be staggered at an angle range of 1° to 89°, so that four different diameter measurements are carried out.

Moreover it can be provided that a measuring device according to the invention for measuring the length and/or the diameter is arranged on drum 7 (FIG. 1). For carrying out the measurements, channel 5 features windows or the like in the area of the measuring places.

In further developments, the measurements are carried out at periodic intervals of time. The use of a light barrier is not required for the periodic length measurements of the filter bars. In the periodic diameter measurements, filter bars that have broken open are more easily detected by this.

Based on the ascertained measuring results of the length and the diameter, it can be checked whether the filter rod meets certain criteria with respect to its length and/or its diameter. In this manner, if the deviations from a predetermined tolerance range are too great, the filter bar is removed from the manufacturing process. Thus, only filter bars with a particular quality are used for the production of filter cigarettes or multi-segment filters.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Reference Numbers

1 Connecting line 25.2 Mirror
2 Curved guide 26.1 Mirror
3 Braking roller 26.2 Mirror
4 Accelerating roller 27 Streak of light
5 Channel 28.1 Partial streak of light
6 Filter bar 28.2 Partial streak of light
7 Drum 28.3 Partial streak of light
8 Magazine 28.4 Partial streak of light
9 Receptacle 30 Streak of light
10 Measuring device 29 Mirror
11 Laser light source 31 Shadow
12 Lamp 32.1 Mirror
13 Sensor 32.2 Mirror
14 Detector (edge) 32.3 Mirror
15 Delay element 32.4 Mirror
16 Start element 33 Light beam
17 Line 34 Streak of light
18 Start element (readout) 35 Mirror
19 Connection L Length
20 Line camera d₁ Diameter
21 Shadow d₂ Diameter
22 Line F Conveying direction
23 Line P Position
24 Microcomputer P1 Position
25.1 Mirror P2 Position

1. A process for measuring bar-shaped articles, comprising:
conveying the bar-shaped articles in a conveyor line; and
optically measuring at least one physical property of the bar-shaped articles.

2. The process in accordance with claim 1, wherein the at least one physical property is a geometric property.

3. The process in accordance with claim i, wherein the bar-shaped articles comprise filter bars.

4. The process in accordance with claim 1, wherein the process is performed on bar-shaped articles of the tobacco processing industry.

5. The process in accordance with claim 1, wherein the at least one physical property comprises at least one of a length and a diameter of the bar-shaped articles.

6. The process in accordance with claim 1, wherein at least two different physical properties of the bar-shaped articles are measured.

7. The process in accordance with claim 6, wherein the at least two different physical properties are measured at a same time.

8. The process in accordance with claim 1, wherein the at least one physical property is measured several times.

9. The process in accordance with claim 1, wherein the at least one physical property comprises at least two physical properties, and the at least two physical properties are measured several times.

10. The process in accordance with claim 9, wherein the at least two physical properties are measured simultaneously.

11. The process in accordance with claim 1, further comprising pneumatically measuring the at least one physical property.

12. The process in accordance with claim 1, further comprising, after measuring the at least one physical property, determining whether the at least one measured physical property lies within a predetermined measurement range.

13. The process in accordance with claim 1, wherein, when the measured physical property lies outside of the predetermined measurement range, the process further comprises removing the bar-shaped article from at least one of the conveyor line and the manufacturing process.

14. The process in accordance with claim 1, further comprising triggering a start signal, wherein the measurement of the physical property occurs after the start signal is triggered.

15. The process in accordance with claim 14, wherein the start signal is triggered by a light barrier.

16. The process in accordance with claim 1, wherein the at least one physical property is measured in the end area of the bar-shaped articles.

17. The process in accordance with claim 1, wherein two measuring points are arranged along a conveying zone of the bar-shaped articles, and the measuring performed by the two measuring points along the conveying zone of the articles.

18. The process in accordance with claim 17, wherein the two measuring points are arranged to measure the length of the bar-shaped articles.

19. The process in accordance with claim 17, further comprising impinging light upon at least one of the bar-shaped articles and the two measuring points.

20. The process in accordance with claim 19, wherein at least one light source is positioned to impinge light upon the at least one of the bar-shaped articles and the two measuring points.

21. The process in accordance with claim 20, wherein the at least one light source comprises a laser light source.

22. The process in accordance with claim 20, wherein the measurement of at least one physical property is based on an area of the article impinged upon by the light source and based on a brightness profile produced.

23. The process in accordance with claim 22, wherein the brightness profile is detected by a sensor.

24. The process in accordance with claim 23, wherein the sensor comprises a line sensor.

25. A device for conveying bar-shaped articles to a magazine comprising:
an optical measuring device structured and arranged to measure at least one physical property of the filter bars.

26. The device in accordance with claim 25, wherein the bar-shaped articles comprises filter bars and the magazine comprises a filter magazine.

27. The device in accordance with claim 26, further comprising a device that conveys the filter bars in a lengthwise axial manner and-feeds the filter bars to the filter magazine in a crosswise axial manner.

28. The device in accordance with claim 25, wherein said measuring device is positioned to measure geometric properties of the bar-shaped articles.

29. The device in accordance with claim 25, further comprising:
a conveyor line arranged to convey the bar-shaped articles; and
said measuring device being arranged along said conveyor line.

30. The device in accordance with claim 25, further comprising a braking device and an accelerating device for the bar-shaped articles; and
said measuring device being located between said braking device and said accelerating device.

31. The device in accordance with claim 30, wherein said braking device comprises a pair of braking rollers, and said accelerating device comprises a pair of accelerating rollers.

32. The device in accordance with claim 25, further comprising:
a crosswise conveying unit for the bar-shaped articles; and
said measuring device being located on said crosswise conveying device.

33. The device in accordance with claim 32, wherein said crosswise conveying device comprises a drum.

34. The device in accordance with claim 25, wherein said measuring device comprises at least one light source and at least one sensor.

35. The device in accordance with claim 34, wherein said at least one light source comprises a laser light source and said at least one sensor comprises a line sensor.

36. The device in accordance with claim 25, wherein the measuring device is structured and arranged to measure a length and a diameter of the bar-shaped articles at a same time.

37. The device in accordance with claim 25, wherein the measuring device comprises one of at least one mirror and a mirror arrangement.

38. The device in accordance with claim 25, further comprising an evaluating device structured and arranged to evaluated measurements from said measuring device.

39. The device in accordance with claim 38, further comprising an ejection device structured and arranged to eject the bar-shaped articles that is coupled to said evaluating device.

40. An apparatus comprising:
a conveyor for bar-shaped articles; and
a measuring device coupled to said conveyor to measure at least one geometric property of the bar-shaped articles.

41. The apparatus in accordance with claim 40, wherein said measuring device comprises a unit for measuring at least one of a length and a diameter of the bar-shaped article.

42. The apparatus in accordance with claim 41, wherein the length and the diameter are simultaneously measured.

43. The apparatus in accordance with claim 42, wherein said measuring device comprises a light source and an optical receiver, and the bar-shaped articles are conveyed through light emitted from said light source, and the measurement is based upon an amount of the light emitted from said light source that is blocked from said optical receiver by the bar-shaped articles.

44. The apparatus in accordance with claim 41, wherein a position of both ends of the bar-shaped articles are concurrently detected in order to measure the length of the bar-shaped articles.

45. The apparatus in accordance with claim 41, wherein two orthogonal diameters of the bar-shaped articles are concurrently detected in order to measure the diameter of the bar-shaped articles.

46. A process for providing bar-shaped articles, comprising:
conveying the bar-shaped articles; and
measuring at least one geometric property of the bar-shaped articles.

47. The process in accordance with claim 46, wherein the measured geometric property comprises at least one of a length and a diameter of the bar-shaped article.

48. The process in accordance with claim 47, further comprising simultaneously measuring the length and the diameter.

49. The process in accordance with claim 48, wherein the bar-shaped articles are conveyed through light emitted from a light source, and the measurement is based upon an amount of the light emitted from the light source that is blocked from an optical receiver by the bar-shaped articles.

50. The process in accordance with claim 47, further comprising concurrently detecting a position of both ends of the bar-shaped articles in order to measure the length of the bar-shaped articles.

51. The process in accordance with claim 47, further comprising concurrently detecting two orthogonal diameters of the bar-shaped articles in order to measure the diameter of the bar-shaped articles.
